(19) United States
(12) Patent Application Publication
(10) Pub. No.: US 2019/0153914 A1
(43) Pub. Date: May 23, 2019

(54) HYBRID OIL PUMP

(71) Applicant: PIERBURG PUMP TECHNOLOGY GMBH, Neuss (DE)

(72) Inventors: Marco PARISI, Napoli (IT); Alessandro MALVASI, Livorno (IT)

(73) Assignee: Pierburg Pump Technology GmbH, Neuss (DE)

(21) Appl. No.: 16/091,105

(22) PCT Filed: Apr. 7, 2016
(86) PCT No.: PCT/EP2016/057556

§ 371 Date: Oct. 4, 2018

(51) Int. Cl. F01M 1/02; F02B 67/06; F02B 67/08; F16H 61/00; F16H 57/04; F16D 41/069; F16D 41/12; F16D 25/00

(52) U.S. Cl. CPC F01M 1/02; F02B 67/06; F02B 67/08; F16H 61/0028; F01M 2001/0253; F16D 41/069; F16D 41/12; F16D 25/00; F16H 57/0439

(57) ABSTRACT

A hybrid oil pump for a vehicle with an engine. The hybrid oil pump includes an oil pump unit with a pump shaft, a mechanical drive to drive the oil pump unit in a mechanical driving mode, an electrical drive to drive the oil pump unit in an electrical driving mode, a switchable clutch arranged between the motor shaft and the pump shaft, and a freewheel clutch to automatically couple the mechanical drive with the pump shaft when a rotational speed of the mechanical drive is higher than a rotational speed of the electric motor. The oil pump unit pumps pressurized oil to a vehicle component. The mechanical drive is mechanically connected to and driven by the engine. The electrical drive includes an electric motor and a motor shaft. The switchable clutch mechanically disengages the electrical drive from the oil pump unit in the mechanical driving mode.

### CROSS REFERENCE TO PRIOR APPLICATIONS

This application is a U.S. National Phase application under 35 U.S.C. § 371 of International Application No. PCT/EP2016/057556, filed on Apr. 7, 2016. The International Application was published in English on Oct. 12, 2017 as WO 2017/174133 A1 under PCT Article 21(2).

### FIELD

The present invention relates to a hybrid oil pump for a vehicle comprising an engine for driving the vehicle, for example, an internal combustion engine or an electrical engine.

### BACKGROUND

A typical example for the use of a hybrid oil pump is to provide oil pressure even when the internal combustion engine is not running, for example, when the engine stops for a few seconds in a start/stop modus or is in a sailing modus. When the engine is stopped, the pressurized oil is used for a pre-lubrication of, for example, the bearings, for a post-lubrication, to cool and lubricate a turbine, and to maintain the oil pressure in other hydraulic devices, for example, in a hydraulic cam-phaser. The pressurized oil is also used to maintain the oil pressure in the clutches of an automotive gearbox.

The hybrid oil pump comprises an oil pump unit for pumping pressurized oil to a vehicle component. The oil pump is provided with a mechanical drive for driving the oil pump unit in a mechanical driving mode, wherein the mechanical drive is mechanically connected to and driven by the engine. The oil pump is also provided with an electrical drive for driving the pump unit in an electrical driving mode when the engine is not rotating, but the oil pump still needs to be active.

### SUMMARY

An aspect of the present invention is to provide a hybrid oil pump having a simple construction and an improved efficiency.

In an embodiment, the present invention provides a hybrid oil pump for a vehicle comprising an engine. The hybrid oil pump includes an oil pump unit comprising a pump shaft, a mechanical drive configured to drive the oil pump unit in a mechanical driving mode, an electrical drive configured to drive the oil pump unit in an electrical driving mode, a switchable clutch arranged between the motor shaft of the electrical drive and the pump shaft of the oil pump unit, and a freewheel clutch configured to automatically couple the mechanical drive with the pump shaft when a rotational speed of the mechanical drive is higher than a rotational speed of the electric motor. The oil pump unit is configured to pump a pressurized oil to a vehicle component. The mechanical drive is mechanically connected to and driven by the engine. The electrical drive comprises an electric motor and a motor shaft. The switchable clutch is configured to mechanically disengage the electrical drive from the oil pump unit in the mechanical driving mode.

### BRIEF DESCRIPTION OF THE DRAWINGS

The present invention is described in greater detail below on the basis of embodiments and of the drawings in which:

FIG. 1 shows a schematic drawing of an arrangement comprising an internal combustion engine and a hybrid oil pump according to an embodiment of the present invention;

FIG. 2 shows a cross section of an embodiment of a freewheel clutch of the hybrid oil pump of FIG. 1; and

FIG. 3 shows a cross section of another embodiment of a freewheel clutch.

### DETAILED DESCRIPTION

The hybrid oil pump is provided with an oil pump unit for pumping pressurized oil to a vehicle component. A vehicle component in the meaning of the present invention is, for example, the gearbox, the internal combustion engine, the steering unit, or heat exchangers. The pump is provided with a mechanical drive to drive the pump unit in a mechanical driving mode and with an electrical drive to drive the pump unit in an electrical driving mode. The mechanical drive is driven by the engine. This engine can, for example, be an internal combustion engine. The hybrid oil pump is further provided with a switchable clutch which is arranged mechanically between a motor shaft of the electrical drive and a pump shaft of the oil pump unit. The switchable clutch mechanically disengages the electrical drive from the oil pump unit in the mechanical driving mode. The hybrid oil pump is provided with a freewheel clutch arranged mechanically between the mechanical drive and the electrical drive. The freewheel clutch according to the present invention is designed so that the mechanical drive is automatically coupled with the pump shaft of the pump unit when the rotational speed of the mechanical drive is higher than the rotational speed of the electric motor.

During a mechanical driving mode, the electric motor stands still in the driving mode as the switchable clutch disengages the motor shaft of the electric motor from the pump shaft of the pumping unit. The electric motor is therefore mechanically protected. The efficiency of the hybrid oil pump is thereby improved.

Because the clutch is switchable, the switching moment can be exactly determined.

In an embodiment of the present invention, the switchable clutch can, for example, be a hydraulically actuated clutch. The fluid for hydraulically actuating the switchable clutch may be provided, for example, by a separate hydraulic pump which also provides fluid to other hydraulic units or by the pump unit of the hybrid oil pump itself.

In an embodiment of the present invention, the hydraulic actuated switchable clutch can, for example, be hydraulically connected to the pump unit. The pump unit accordingly supplies fluid to the vehicle component and to the hydraulic switchable clutch. An additional hydraulic source for actuating the hydraulic clutch is therefore not necessary. The hybrid oil pump has a simple construction and operates efficiently.

The hydraulically actuated switchable clutch can, for example, be a form-closure clutch. The coupling elements in a form-closure clutch are locked with each other via a form-closure. The transmission of high torque with a high reliability is thereby provided. Because the transmission of the force in the locked state is accomplished via the form-closure, only a low actuating force is necessary to engage or to disengage the clutch.

The switchable clutch is alternatively a friction clutch. The friction clutch allows a reliable operation of the clutch.

In an embodiment of the present invention, the mechanical drive can, for example, comprise a pulley wheel which is driven by a belt. In an embodiment of the present invention, the mechanical drive can, for example, comprise a chain wheel which is driven by a chain driven by the engine instead of the pulley wheel. A chain wheel allows for a slip-free transmission.

A driving arrangement is provided, which can, for example, comprise the freewheel clutch and the pulley wheel. The freewheel clutch forms a hub of the pulley wheel. The inner race of the freewheel clutch is mechanically connected to the pump shaft. Because the freewheel clutch and the pulley wheel are provided as a single functional unit, no further axial space is needed to accommodate the freewheel clutch. The required space for the mechanical drive can therefore be reduced.

In an embodiment of the present invention, a driving arrangement can, for example, be provided which comprises the freewheel clutch and the chain wheel. The freewheel clutch forms a hub of the chain wheel. The inner race of the freewheel clutch is mechanically connected to the pump shaft. The driving arrangement comprising the chain wheel is very compact.

In an embodiment of the present invention, the motor-rotor of the electric motor can, for example, be permanently magnetized. An electric motor with a permanently magnetized motor-rotor operates very efficiently. However, this type of motor generates a magnetic resistance torque when the motor-rotor is dragged in a non-operating state of the electric motor. Using the aforesaid electric motor type in the hybrid oil pump allows the electric motor to be disengaged to thereby avoid any dragging torque when the oil pump is driven mechanically. The very efficient electric motor type with a permanently magnetized motor-rotor can be used without having the disadvantage of a dragging torque in the mechanical driving mode.

In an embodiment of the present invention, the freewheel clutch can, for example, comprise an outer race having sawtooth depressions at its inner circumferential surface. The freewheel clutch further comprises an inner race, which is provided within the outer race, so as to be rotatable in one rotational direction with respect to the outer race. The inner race comprises at least one, for example, four pawls, extending in an outer circumferential surface thereof. The pawl is thereby provided so that the pawl interacts with the sawtooth depressions so as to block one rotational direction of the inner race with respect to the outer race.

In an embodiment of the present invention, the pawl can, for example, be mechanically preloaded in a radial direction via a spring so that one end of the pawl is in permanent contact with the sawtooth depressions so as to block one rotational direction of the inner race with respect to the outer race. The spring can, for example, be a spiral spring or a leaf spring. A leaf spring is inexpensive. In an embodiment of the present invention, the pawl itself can, for example, be made of a resilient material.

The freewheel clutch with the arrangement of the pawls extending the inner race is fail-safe. In case of a failure of the springs preloading the free ends of the pawls in a radial direction, the free ends will be forced in the direction of the sawtooth depressions by centrifugal force generated during rotation of the inner race. When the internal combustion engine again restarts, the rotational speed of the outer race becomes faster than the rotational speed of the inner race. Because the free ends of the pawls are in contact with the sawtooth depressions due to centrifugal force, the other rotational direction of the inner race relative to the outer race is blocked. The inner race accordingly co-rotates with the outer race. When the inner race co-rotates with the outer race, the free ends of the pawls lock with the respective sawtooth depressions. By co-rotating the inner race with the outer race, the free ends will still be forced in the direction to the sawtooth depressions by the centrifugal force generated by the co-rotation of the inner race. The electrical drive can be switched off.

A detailed description of an embodiment of the present invention is set forth below under reference to the drawings.

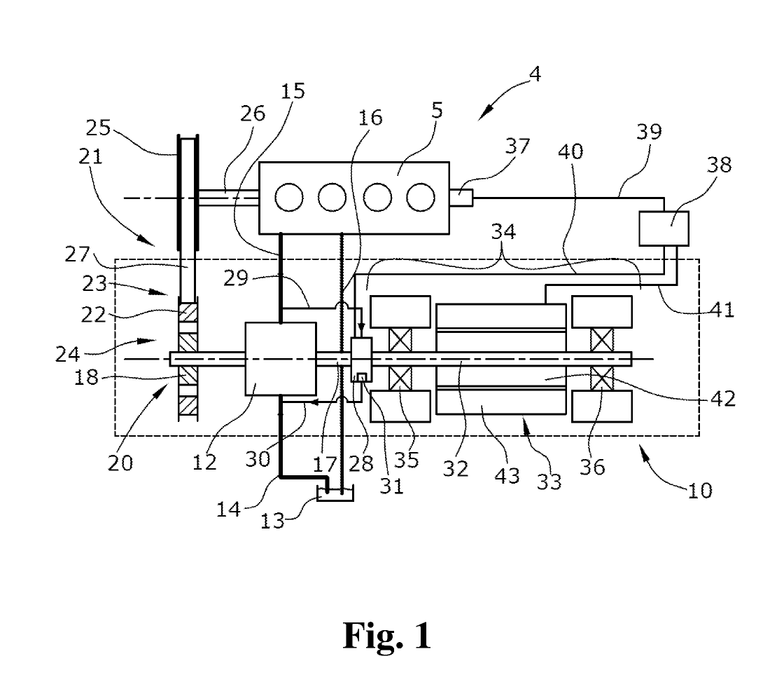

FIG. 1 shows a schematic representation of an arrangement 4 comprising a vehicle driving engine 5 and a hybrid oil pump 10. According to the described embodiment, the engine 5 is exemplarily an internal combustion engine. The hybrid oil pump 10 comprises an oil pump unit 12 which pumps oil from an oil sink 13 to a vehicle component via an oil sink conduit 14 and an oil delivery conduit 15. The vehicle component according to the described embodiment is exemplarily the internal combustion engine 5. The oil from the internal combustion engine 5 is discharged to the oil sink 13 by an oil discharge conduit 16.

A pump rotor of the oil pump unit 12 is mechanically fixed to a pump shaft 17. One axial end of the pump shaft 17 is fixed to an inner race 18 of a freewheel clutch 20 of a driving arrangement 21. The freewheel clutch 20 further comprises an outer race 22, which also defines a pulley wheel 23. The inner race 18 is provided radially within the outer race 22 so as to be rotatable in one rotational direction relative to the outer race 22. In the other relative rotational direction, the outer race 22 blocks a relative rotation of the inner race 18 so that the inner race 18 co-rotates with the outer race 22.

The internal combustion engine 5 mechanically drives a mechanical drive 24. The mechanical drive 24 comprises the pulley wheel 23, and is driven by an engine driving wheel 25 which is driven by the internal combustion engine 5 via an engine shaft 26. The engine driving wheel 25 is mechanically connected to the pulley wheel 23 via a belt 27. The oil pump unit 12 therefore is mechanically connected and driven by the internal combustion engine 5.

The other axial end of the pump shaft 17 is mechanically connected to a hydraulically switchable clutch 28. A typical example of a hydraulically switchable clutch 28 is described in WO 2015/090416 A1. Reference is thereby made to page 6, line 19, to page 10, line 13, of WO 2015/090416 A1, which together with the respective figures are incorporated by reference herein.

The hydraulically switchable clutch 28 is connected to the oil pump unit 12 via a clutch actuation conduit 29 and a clutch discharge conduit 30 for providing actuation pressure from the oil pump unit 12 so as to hydraulically actuate the hydraulically switchable clutch 28. The hydraulically switchable clutch 28 is provided with a valve 31 for fluidically connecting or disconnecting the clutch actuation conduit 29 to the clutch discharge conduit 30. By opening the valve 31 and thereby connecting the clutch actuation conduit 29 to the clutch discharge conduit 30, the hydraulically switchable clutch 28 is switched into a non-actuated state. In the non-actuated state of the hydraulically switchable clutch 28, a spring (not shown in the drawings), provided in the hydraulically switchable clutch 28, acts on engaging parts (not shown in the drawings) of the hydraulically switchable clutch 28 so as to bring the hydraulically switchable clutch 28 into an engaged state. In the engaged state, the hydraulically switchable clutch 28 mechanically engages the pump shaft 17 to a motor shaft 32 of an electric motor 33 being part of an electrical drive 34 of the hybrid oil pump 10. The oil pump unit 12 is thereby mechanically drivable by the electrical drive 34 in an electric driving modus, in which the hydraulically switchable clutch 28 is engaged.

The hydraulically switchable clutch 28 is in an actuated state by closing the valve 31, and thereby disconnecting the clutch actuation conduit 29 to the clutch discharge conduit 30. In the actuated state, the pressure of the oil pump unit 12 acts against the spring force so that the engaging parts are shifted into a disengaged position. In the disengaged state, the hydraulically switchable clutch 28 mechanically disengages the pump shaft 17 from the motor shaft 32.

The arrangement with the hydraulically switchable clutch 28 is fail-safe because the hydraulically switchable clutch 28 is engaged in a non-actuated state. If the valve 31 fails, the hydraulically switchable clutch 28 returns or remains in an engaged state in which the electrical drive 34 permanently co-rotates.

The electrical drive 34 further comprises bearings 35, 36 supporting the motor shaft 32.

When the internal combustion engine 5 is in a stop mode, namely not rotating, the oil pump unit 12 is not further mechanically driven by the non-rotating mechanical drive 24. A temperature sensor 37 detects the temperature of the internal combustion engine 5 and forwards the temperature signal to an electronic control device 38 via an electric signal line 39. If the temperature exceeds a predetermined value, the electronic control device 38, which is also connected to the hydraulic switchable clutch 28 via a clutch signal line 40, activates the coupling process so that the hydraulically switchable clutch 28 switches to a coupled condition. The electronic control device 38 can also be connected with a rotation speed signal of a speed sensor detecting the rotation speed of the internal combustion engine 5, the pulley wheel 23, or the engine driving wheel 25.

The electronic control device 38 starts the electric motor 33 by sending an electric signal via an electric motor signal line 41 connected to the electric motor 33. The electric motor 33 then drives the oil pump unit 12 so that pressurized oil is forwarded to the internal combustion engine 5 and the temperature of the internal combustion engine 5 is decreased. The inner race 18 then rotates with respect to the outer race 22 in a direction which is not blocked. When the internal combustion engine 5 again restarts, the rotational speed of the outer race 22 becomes faster than the rotational speed of the inner race 18. As the other rotational direction of the inner race 18 relative to the outer race 22 is blocked, the inner race 18 co-rotates with the outer race 22. The electronic control device 38 actuates the hydraulically switchable clutch 28 if no internal combustion engine 5 lubrication or internal combustion engine 5 cooling is needed, or if the internal combustion engine 5 is running. The hydraulically switchable clutch 28 switches to a non-coupled condition in which the motor shaft 32 is not coupled to the pump shaft 17. The electronic control device 38 also stops the energizing of the electric motor 33. A motor-rotor 42 of the electric motor 33 therefore does not co-rotate with the pump shaft 17 so that no magnetic losses are generated.

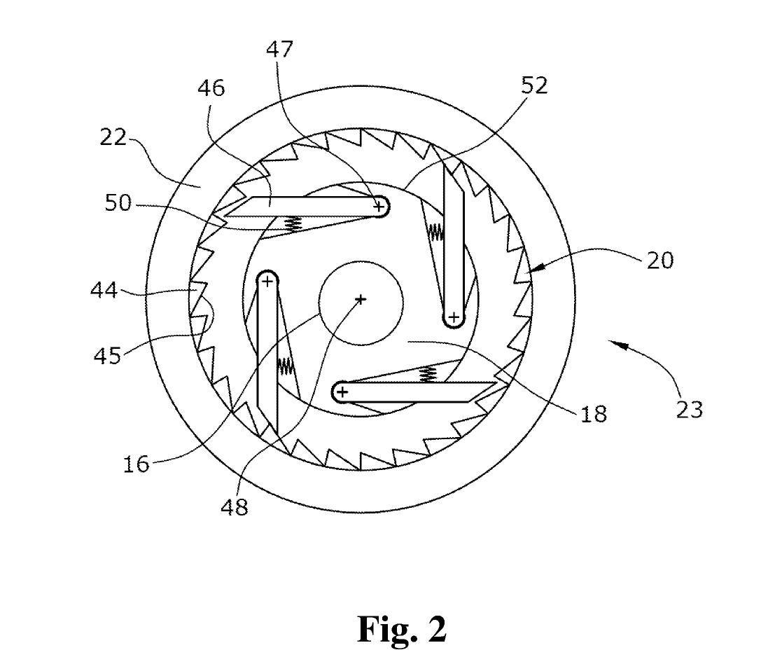

FIG. 2 shows a cross section of a first embodiment of a freewheel clutch 20 with the outer race 22 having sawtooth depressions 44 at its inner circumferential surface 45. In this embodiment of the present invention, the outer race 22 is mechanically fixed at the pulley wheel 23.

The inner race 18 is arranged within outer race 22. The inner race 18 is thereby provided to be rotatable in one direction with respect to the outer race 22. The inner race 18 comprises four pawls 46, where first ends are fixed at the inner race 18 so as to allow a rotation around a rotation axis of the pawl 47 parallel to a rotation axis 48 of the inner race 18. The pawls 46 are preloaded by a spiral spring 50 in a radial outward direction so that the pawls 46 extend outwardly from an outer circumferential surface 52 of the inner race 18. The pawls 46 are preloaded so as to be in permanent contact with the sawtooth depressions 44 of the outer race 22.

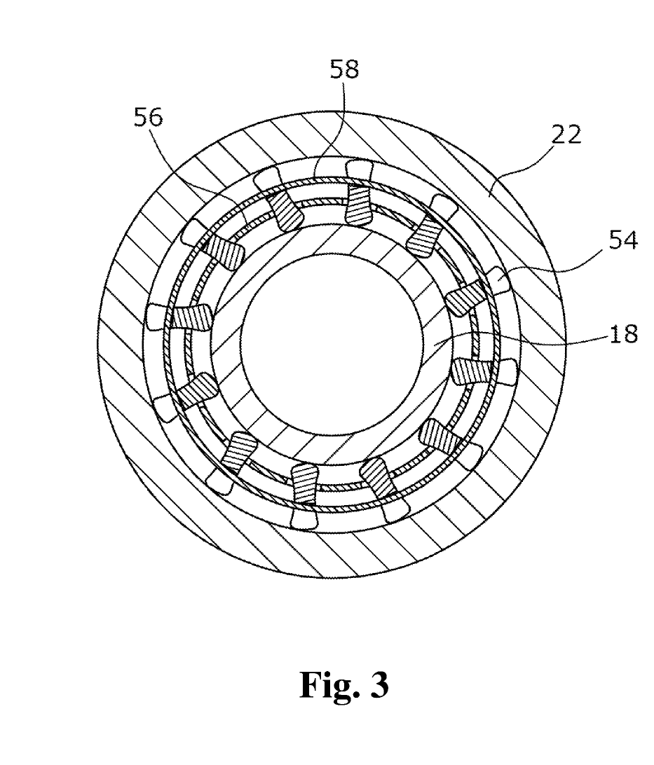

FIG. 3 shows a cross section of a second embodiment of a freewheel clutch 20 providing a plurality of sprag portions 54 arranged between the inner race 18 and the outer race 22. The sprag portions 54 are tiltably provided in a cage 56 so as to allow a relative rotation of the inner race 18 with respect to the outer race 22 in one rotational direction and to block the other rotational direction. A spring ring 58 pretensions the sprag portions 54 to a radial inner direction.

The present invention is not limited to the above described embodiments. Instead of the internal combustion engine, an electrical engine can in particular be used to drive the mechanical drive. Instead of the internal combustion engine, the oil pump unit can also pump pressurized oil to vehicle components such as, for example, the transmission, the gearbox, the steering unit, or heat exchangers.

The present invention is not limited to embodiments described herein; reference should be had to the appended claims.

### LIST OF REFERENCE NUMERALS

4 arrangement
5 engine/internal combustion engine
10 hybrid oil pump
12 oil pump unit
13 oil sink
14 oil sink conduit
15 oil delivery conduit
16 oil discharge conduit
17 pump shaft
18 inner race
20 freewheel clutch
21 driving arrangement
22 outer race
23 pulley wheel
24 mechanical drive
25 engine driving wheel
26 engine shaft
27 belt
28 hydraulically switchable clutch
29 clutch actuation conduit
30 clutch discharge conduit
31 valve
32 motor shaft
33 electric motor
34 electrical drive
35 bearing
36 bearing
37 temperature sensor
38 electronic control device
39 electric signal line
40 clutch signal line
41 electric motor signal line
42 motor-rotor
43 stator coil
44 sawtooth depression
45 inner circumferential surface
46 pawl
47 rotation axis of the pawl
48 rotation axis (of the inner race)
50 spiral spring
52 outer circumferential surface
54 sprag portions
56 cage
58 spring ring

What is claimed is:

1-10. (canceled)

11: A hybrid oil pump for a vehicle comprising an engine, the hybrid oil pump comprising:
an oil pump unit comprising a pump shaft, the oil pump unit being configured to pump a pressurized oil to a vehicle component;
a mechanical drive configured to drive the oil pump unit in a mechanical driving mode, the mechanical drive being mechanically connected to and driven by the engine;
an electrical drive comprising an electric motor and a motor shaft, the electrical drive being configured to drive the oil pump unit in an electrical driving mode;
a switchable clutch arranged between the motor shaft of the electrical drive and the pump shaft of the oil pump unit, the switchable clutch being configured to mechanically disengage the electrical drive from the oil pump unit in the mechanical driving mode; and
a freewheel clutch configured to automatically couple the mechanical drive with the pump shaft when a rotational speed of the mechanical drive is higher than a rotational speed of the electric motor.

12: The hybrid oil pump as recited in claim 11, wherein the switchable clutch is a hydraulically actuated switchable clutch.

13: The hybrid oil pump as recited in claim 12, wherein the hydraulically actuated switchable clutch is hydraulically connected to the oil pump unit.

14: The hybrid oil pump as recited in claim 12, wherein the hydraulically actuated switchable clutch is provided as a form-closure clutch.

15: The hybrid oil pump as recited in claim 11, wherein the switchable clutch is a friction clutch.

16: The hybrid oil pump as recited in claim 11, wherein the mechanical drive comprises a chain wheel which is driven by a chain.

17: The hybrid oil pump as recited in claim 16, wherein the hybrid oil pump further comprises a driving arrangement comprising the freewheel clutch and the chain wheel.

18: The hybrid oil pump as recited in claim 11, wherein the mechanical drive comprises a pulley wheel which is driven by a belt.

19: The hybrid oil pump as recited in claim 18, wherein the hybrid oil pump further comprises a driving arrangement comprising the freewheel clutch and the pulley wheel.

20: The hybrid oil pump as recited in claim 11, wherein the electric motor comprises a motor-rotor which is permanently magnetized.
